(19) United States
(12) Patent Application Publication
(10) Pub. No.: US 2026/0052455 A1
(43) Pub. Date: Feb. 19, 2026

(54) System and Method for Sequencing Passive Channel Scans

(71) Applicant: ZEBRA TECHNOLOGIES CORPORATION, Lincolnshire, IL (US)

(72) Inventors: Venkata Aneel Kumar Inuganti, Bangalore (IN); Mahesh Kumar Edar, Davenagere (IN); Darpan Majumder, Bangalore (IN)

(21) Appl. No.: 18/805,965

(22) Filed: Aug. 15, 2024

(51) Int. Cl. H04W 48/16; H04W 16/10; H04W 48/14

(52) U.S. Cl. CPC H04W 48/16; H04W 16/10; H04W 48/14

(57) ABSTRACT

An example computing device includes: a first communications interface configured to connect to a network; a controller connected to the first communications interface, the controller configured to: detect a roam condition to scan a plurality of base stations; obtain, via a second communications interface, beacon data for a subset of the plurality of base stations; designate a scanning sequence for the plurality of base stations and corresponding channels based on the beacon data for the subset of the plurality of base stations; scan the corresponding channels according to the scanning sequence that is based on the beacon data for the subset of the plurality of base stations and obtain scan results; and select a target base station from the plurality of base stations and roam to the target base station.

### BACKGROUND

Wireless networks may be serviced by several access points to which mobile devices can connect based on their location within the wireless network. As users of mobile devices move around, the mobile devices may roam to different access points. When connecting to an access point or roaming between access points, the device may perform a scan to identify potential access points by performing channel scans to detect access points operating on a given channel. However, such channel scans require the device to move away from the home access point channel for the duration of the scan, which may cause packets to be dropped from ongoing communications.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of a system for sequencing passive channel scans.

FIG. 2 is a block diagram of certain internal hardware components of certain devices of FIG. 1.

FIG. 3 is a flowchart of an example method of sequencing passive channel scans.

FIG. 4 is a flowchart of an example method of obtaining beacon data at block 310 of the method of FIG. 3.

FIG. 5 is a schematic diagram of an example performance of defining a scanning sequence at block 315 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a device comprising: a first communications interface configured to connect to a network; a controller connected to the first communications interface, the controller configured to: detect a roam condition to scan a plurality of base stations; obtain, via a second communications interface, beacon data for a subset of the plurality of base stations; designate a scanning sequence for the plurality of base stations and corresponding channels based on the beacon data for the subset of the plurality of base stations; scan the corresponding channels according to the scanning sequence that is based on the beacon data for the subset of the plurality of base stations and obtain scan results; and select a target base station from the plurality of base stations based on the scan results and roam to the target base station.

Additional examples disclosed herein are directed to a method comprising: detecting a roam condition to scan a plurality of base stations; obtaining, via a second communications interface, beacon data for a subset of the plurality of base stations; designating a scanning sequence for the plurality of base stations and corresponding channels based on the beacon data for the subset of the plurality of base stations; scanning the corresponding channels according to the scanning sequence that is based on the beacon data for the subset of the plurality of base stations and obtain scan results; and selecting a target base station from the plurality of base stations based on the scan results and roaming to the target base station.

Additional examples disclosed herein are directed to a non-transitory machine-readable storage medium storing instructions which when executed cause a computing device to: detect a roam condition to scan a plurality of base stations; obtain, via a second communications interface, beacon data for a subset of the plurality of base stations; designate a scanning sequence for the plurality of base stations and corresponding channels based on the beacon data for the subset of the plurality of base stations; scan the corresponding channels according to the scanning sequence that is based on the beacon data for the subset of the plurality of base stations and obtain scan results; and select a target base station from the plurality of base stations based on the scan results and roam to the target base station.

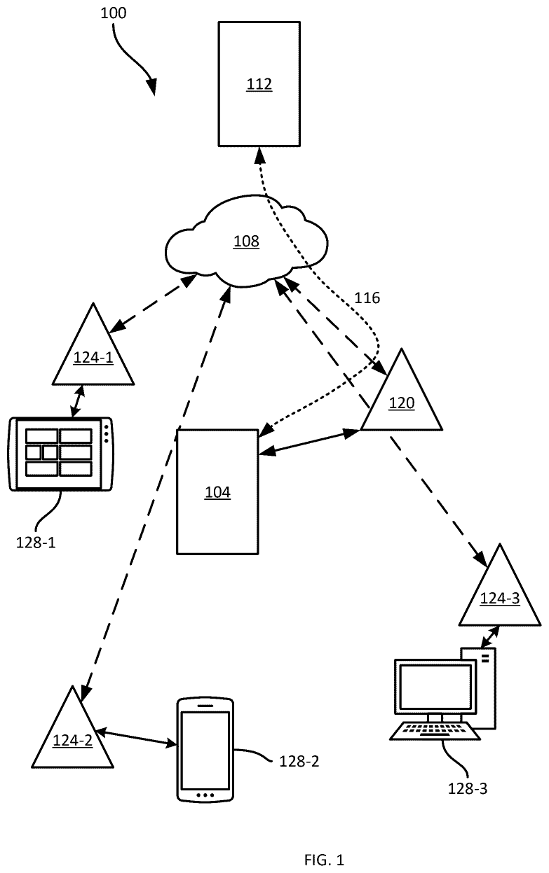

FIG. 1 depicts a system 100 for sequencing passive channel scans in accordance with the teachings of this disclosure. The system 100 includes a computing device 104 (also referred to herein as simply the device 104) connected to a network 108. The device 104 may communicate with a second computing device 112 (also referred to herein as the peer device 112) via a link 116 which traverses the network 108. In some examples, the device 112 may be remote from the device 104 and the link 116 may therefore additionally traverse one or more wide-area networks such as the Internet, mobile networks and the like.

The device 104 may be a mobile computing device such as a handheld computer, a mobile phone, a tablet, a barcode scanner or the like. As noted above, the device 104 is connected to the network 108, which may be deployed for wireless communications within a facility, such as a transportations and logistics facility, a warehouse, retail establishment, or other facility. Accordingly, the network 108 may be a wireless local area network (WLAN) and/or a wireless wide area network (WWAN) deployed by one or more base stations, including without limitation one or more access points and/or cellular base stations, citizens broadband radio service (CBRS) base stations, or the like. In the present example, four access points, a home access point 120, and three foreign access points 124-1, 124-2, and 124-3 (referred to herein generically as an access point 124 and collectively as access points 124; this nomenclature is also used elsewhere herein) are depicted. In other examples, the network 108 may include more or fewer access points.

In particular, the device 104 may be currently serviced by the home access point 120 to connect to the network 108. Since the device 104 may be mobile, the device 104 may be carried about by a user. As the user of the device 104 moves about the facility or other region serviced by the network 108, the connection of the device 104 to the home access point 120 may weaken, and the device 104 may be better serviced by another foreign access point 124 of the network 108. Accordingly, the device 104 may scan the foreign access points 124 and may subsequently roam to one of the foreign access points 124 to connect to the network 108, for example when the device 104 is out of range of the home access point 120 and/or when a better connection may be achieved via one of the foreign access points 124.

To identify the foreign access points 124, the device 104 performs an access point scan. During the access point scan, the device 104 may perform multiple channel scans for each of a plurality of channels to identify access points 124 operating on a given channel. Together, the set of channel scans form the access point scan. During each of the channel scans, the device 104 moves away from its current operating channel with the home access point 120, so ongoing communications (e.g., between the device 104 and the device 112) may be buffered until the device 104 returns to the operating channel of the home access point 120.

Wireless communications operating standards may specify that some types of channels, such as dynamic frequency selection (DFS) channels, are restricted. Specifically, scans on DFS channels are restricted to passive scans until activity is detected on a DFS channel prior to switching to an active scans. That is, scanning devices are configured to passively wait for detection of a beacon signal emitted periodically by an access point operating on the DFS channel. Accordingly, DFS scans may take up to 100 ms (or another suitable predetermined default scan time) to complete depending on the time at which the passive scan was initiated and the time and interval at which beacon signals are emitted by the foreign access point operating on the DFS channel. This length of time increases the chances of dropping packets while the device 104 is away from the home access point during each channel scan.

Thus, in accordance with the present disclosure, upon detecting a roam condition, the device 104 may be configured to obtain beacon data for a subset of the foreign access points 124, in particular, for the foreign access points 124 which operate on DFS channels or other channels requiring passive scans. The beacon data may specify, for a given foreign access point 124, a time at which the next beacon signal is to be emitted (e.g., expressed as a clock time according to an external standardized datetime system, as a target amount of time until the next beacon signal, or the like) and a beacon interval representing the period between beacons.

In particular, the device 104 obtains the beacon data via a secondary communications protocol, such as Bluetooth Low Energy. For example, the device 104 may obtain the beacon data from nearby secondary computing devices, such as secondary computing devices 128-1, 128-2, and 128-3 connected to access points 124-1, 124-2, and 124-3, respectively. The computing devices 128 may be computing devices such as printers, laptops, desktop computers, fixed workstations, other mobile computing devices, such as scanners, tablets, mobile phones, or the like. The device 104 may broadcast a request for the beacon data via the secondary communications protocol. Upon receiving such a request from the scanning device 104 at the secondary computing devices 128, if the channels on which the corresponding access points 124 are operating are DFS channels, the secondary computing devices 128 may respond to the request with the respective beacon data for the respective access point 124. In other examples, the request may be received by the foreign access point 124 itself, and the foreign access point 124 may respond to the request, or the foreign access point 124 may be configured to broadcast its beacon data periodically via the secondary communications protocol.

Upon obtaining the beacon data for the access points operating on DFS or other passive scanning channels, or a subset thereof (e.g., at least a threshold proportion of the DFS channels or the like), the device 104 may then define a scanning sequence to optimize scanning of the DFS channels to align with a time at which a beacon signal is expected on the given DFS channel. That is, the system may sequence the DFS channels such that the device 104 moves to a given DFS channel just prior to an expected beacon signal. The device 104 may therefore reduce the time spent on DFS channels or other passive scanning channels waiting for a beacon signal, and therefore reduce the amount of time spent away from the home channel and reduce the likelihood of dropped packets.

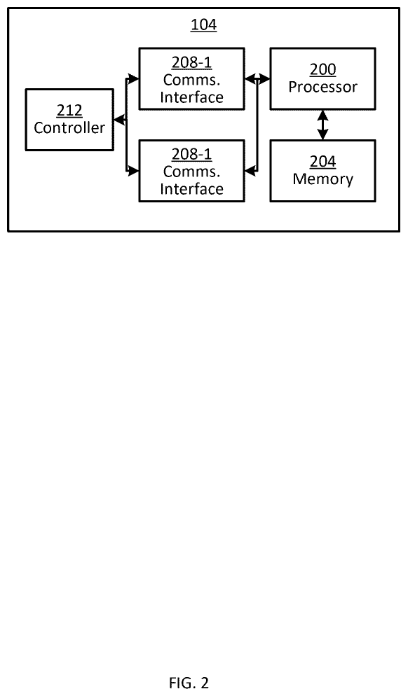

Turning now to FIG. 2, certain internal components of the computing device 104 are illustrated. The device 104 includes a processor 200 interconnected with a non-transitory computer-readable storage medium, such as a memory 204. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 200 and the memory 204 may each comprise one or more integrated circuits. The memory 204 stores computer-readable instructions for execution by the processor 200, including one or more applications which, when executed, configure the processor 200 to perform the various functions of the device 104.

The device 104 further includes first and second communications interfaces 208-1 and 208-2 enabling the device 104 to exchange data with other computing devices, such as the device 112. The communications interfaces 208 are interconnected with the processor 200. The communications interfaces 208 may be controlled by a controller 212, and one or more antennas, transmitters, receivers, or the like (not shown), to allow the device 104 to communicate with other computing devices. For example, the first communications interface 208-1 may include suitable components to enable the device 104 to communicate over the network 108. The second communications interface 208 may further allow the device 104 to communicate with (e.g., to broadcast signals, via a two-way communication link, etc.) other computing devices such as the devices 128 according to a secondary communications protocol, such as a Bluetooth Low Energy protocol or other suitable short-range wireless communication protocol.

The controller 212 may be a micro-controller, a micro-processor, or other suitable device capable of executing computer-readable instructions to control the components, such as the antennae, transmitters, receivers, and the like, of the communications interfaces 208 to perform the functionality described herein. The controller 212 may comprise one or more integrated circuits and may include and/or be interconnected with a non-transitory computer-readable storage medium storing computer-readable instructions which when executed configure the controller 212 and/or the communications interface 208 to perform the functionality described herein. In particular, the controller 212 may control a scan sequencing operation of the device 104.

The device 104 may further include one or more input and/or output devices (not shown) suitable to allow an operator to interact with the device 104. The input devices may include one or more buttons, keypads, touch-sensitive display screens or the like for receiving input from an operator. The output devices may further include one or more display screens, sound generators, vibrators, or the like for providing output or feedback to an operator.

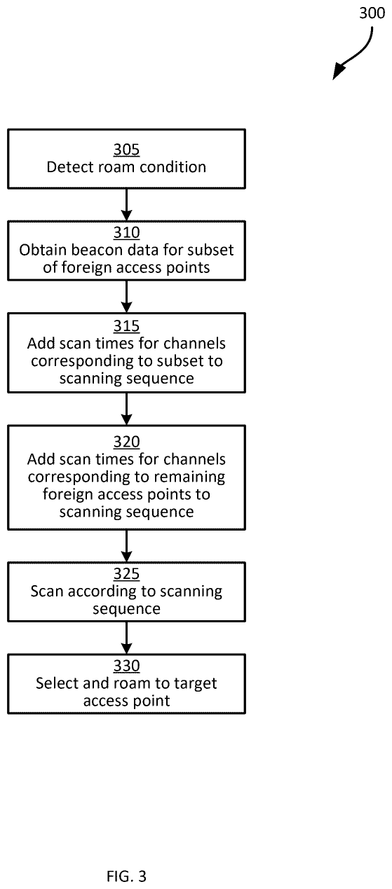

Turning now to FIG. 3, the functionality implemented by the device 104 will be discussed in greater detail. FIG. 3 illustrates a method 300 of sequencing channel scans. The method 300 will be discussed in conjunction with its performance in the system 100, and particularly by the device 104. In particular, the method 300 will be described with reference to the components of FIGS. 1 and 2. In other examples, the method 300 may be performed by other suitable devices or systems.

The method 300 is initiated at block 305, for example in response to the device 104 detecting a roam condition to initiate an access point scan to identify foreign access points to which the device 104 may roam. For example, the device 104 may detect that a signal strength to the home access point 120 is below a threshold strength, that a quality of service (e.g., as determined based on jitter, latency, etc.) is below a predetermined threshold, or other similar condition.

At block 310, the device 104 is configured to obtain, via a secondary communications protocol, beacon data for a subset of the foreign access points. For example, subset may include the foreign access points 124 operating on DFS channels or other passive scanning channels. Further, in some examples, the beacon data may not be available for all of the DFS channels, and accordingly, the subset may include only the access points 124 operating on DFS channels for which beacon data is available.

The beacon data obtained for a given foreign access point 124 may include a target beacon transmit time (TBTT) which provides an indication the amount of time (e.g., in milliseconds) until the subsequent beacon signal is emitted by the foreign access point 124. In other examples, the beacon data may include a specific target time at which the subsequent beacon signal is to be emitted. The beacon data may further include a beacon interval representing the total period between beacon signals. Based on the TBTT and/or target time of the subsequent beacon signal and the beacon interval, the device 104 may be enabled to determine the expected timing of each beacon signal emitted by the foreign access point 124. The device 104 may store the beacon data for the given foreign access point 124 in a cache or other temporary repository for performance of the method 300.

The device 104 is configured to obtain the beacon data via the secondary communications protocol, such as Bluetooth Low Energy or another suitable near field and/or wireless communications protocol. In some examples, the device 104 may obtain the beacon data via passive means, for example by detecting a signal broadcast over the secondary communications protocol by the foreign access point 124. In other examples, the device 104 may actively request the beacon data.

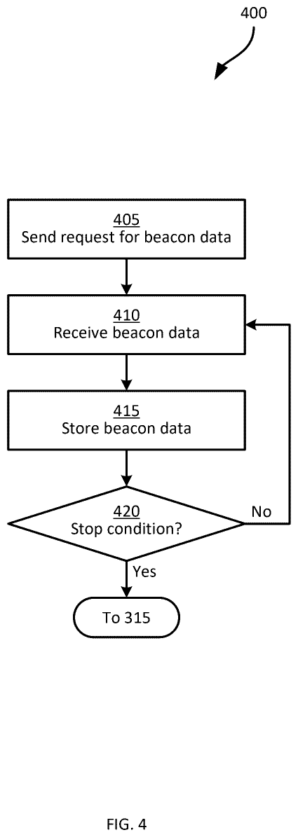

For example, referring to FIG. 4, a flowchart of an example method 400 of obtaining beacon data is depicted. In particular, in the method 400, the device 104 is configured to actively obtain the beacon data.

Accordingly, at block 405, the device 104 is configured to send, via the secondary communications protocol, a request for beacon data. For example, the request may be broadcast or multicast to nearby devices, including the secondary computing devices 128, the access points 120 and 124, and the like.

At block 410, the device 104 is configured to receive beacon data from one of the secondary computing devices 128 or one of the foreign access points 124. As noted above, the beacon data may include the TBTT and the beacon interval, as well as an indication or identifier of the channel for which the beacon data is provided.

In particular, when the secondary devices 128 are connected on DFS or other passive scanning channels, the secondary devices 128 may be configured to track and store the beacon data. Accordingly, upon receiving the request for the beacon data, the secondary devices 128 may respond to the request with the beacon data. When the secondary devices 128 are connected to foreign access points 124 which do not operate on DFS channels, the secondary devices 128 may simply ignore the request received from the device 104.

Additionally or alternatively, the access points 124 may be configured to respond to the request for beacon data according to the internal operational parameters to emit the beacon signals.

At block 415, in response to receiving the beacon data at block 410, the device 104 is configured to store the beacon data according to the channel identifier and/or identifier of the foreign access point 124. In particular, the device 104 may store the TBTT, as well as the time at which the beacon data was received in order to calculate the subsequent timing of emitted beacon signals by the corresponding foreign access point 124. Alternately, the device 104 may translate the TBTT to an internal device time to facilitate the computation of the timing of the beacon signals.

At block 420, the device 104 is configured to determine whether a stop condition has been reached for receiving the beacon data. For example, if beacon data has been received for each of a predefined set of channels, then the device 104 may make an affirmative determination at block 420. In other examples, the stop condition may be a threshold number and/or percentage of the predefined set of channels for which beacon data is received, a timeout condition based on expiry of a predefined period of time in which to receive the beacon data, combinations of the above and the like.

If the determination at block 420 is negative, that is, a stop condition has not yet been reached, then the device 104 is configured to return to block 410 to continue receiving or waiting to receive beacon data from the secondary computing devices 128 and/or from the foreign access points 124.

If the determination at block 420 is affirmative, that is, a stop condition has been identified, then the device 104 is configured to return to block 315 of the method 300.

Returning to FIG. 3, at block 315, the device 104 is configured to define a scanning sequence in which to scan the channels to identify the foreign access points 124. In particular, the device 104 may first sequence the DFS channels (i.e., corresponding to the subset) to be scanned at approximately the expected time of a beacon signal.

For example, the device 104 may designate a start time (i.e., relative to the device time as defined by an internal clock of the device 104) at which to start scanning each of the DFS channels. In particular, the start time may provide a buffer period (e.g., 5 ms, 10 ms) prior to the expected time of a beacon signal to provide sufficient time for channel switching, inaccuracies in the expected beacon time and the like. The device 104 may further designate an expected scan length for each channel. The expected scan length may be at least the length of the buffer period prior to the expected time of a beacon signal and may provide a further buffer period after the expected time of the beacon signal. The further buffer period may similarly provide sufficient time for channel switching and inaccuracies in the expected beacon time. Thus, the sequencing of the DFS channels may be selected to reduce the amount of time spent passively scanning (i.e., waiting for a beacon signal to be detected), since each DFS channel is sequenced to be initiate the scan shortly prior to an expected beacon signal.

The device 104 may then sequence the DFS channels such that none of the channel scans overlap, and to complete all of the channel scans within the shortest period. In particular, if some channel scans overlap at their designated start time, one of the channel scans may be shifted according to the respective beacon interval to align with a previous or subsequent beacon signal.

In some examples, the device 104 may simply sequence the DFS or other passive scanning channels, while in other examples, the device 104 may also sequence other channels for other access points (e.g., channels in which active scanning may be employed). That is, at block 320, the device 104 may sequence the remainder of the channels to be scanned. For example, the device 104 may similarly designate a start time at which to start scanning and an expected scan length for each channel. In some examples, the DFS channels may be sequenced in one block (e.g., including time during which no scans are being performed according to the sequencing of the DFS scans based on the beacon data), while the remainder of the channels are sequenced in another block (e.g., before or after all of the DFS channels have been scanned). In other examples, the scans for the remainder of the channels may be interspersed with the sequenced DFS channel scans to optimize the total scan time. For example, if sufficient time is available between completion of one DFS channel scan and the start time of a subsequent DFS channel scan, the device 104 may sequence an active scanning channel to be scanned in between the DFS channel scans.

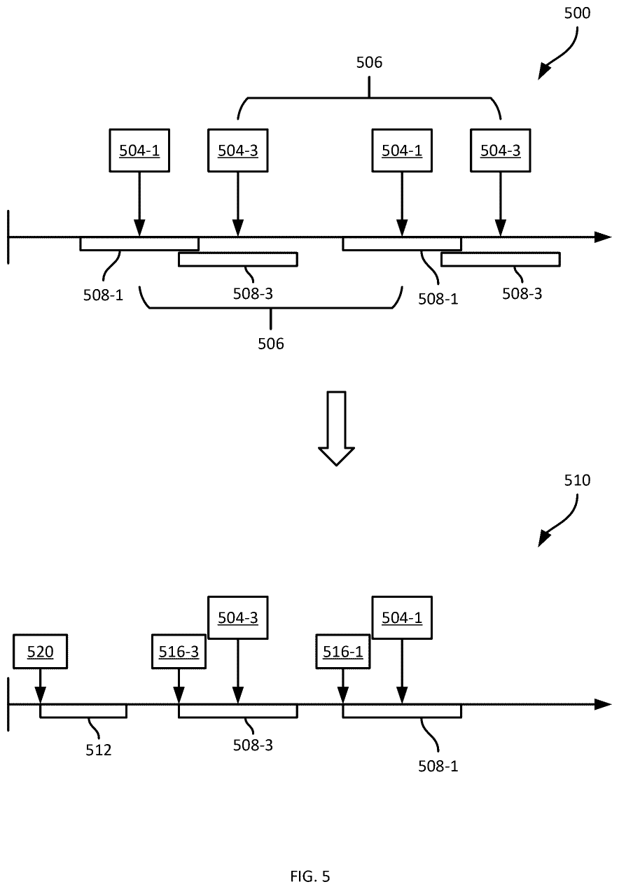

For example, referring to FIG. 5, after performing block 310 of the method 300, the device 104 may obtain beacon data.

In the present example, foreign access points 124-1 and 124-3 may be operating on DFS channels, while the foreign access point 124-2 is not. Accordingly, beacon data may be obtained for the foreign access points 124-1 and 124-3, and not the foreign access point 124-2.

In response to obtaining the beacon data, the device 104 may plot a timeline 500 including the expected beacon times, 504-1 and 504-3 of the foreign access points 124-1 and 124-3, respectively. Further, the timeline 500 may define respective scan lengths 508-1 and 508-3, including buffer periods both before and after the respective expected beacon times 504. In some examples, such as presently illustrated, the timeline 500 may include multiple instances of the expected beacon times 504 and the scan lengths 508, separated along the timeline by the beacon interval 506.

At block 315, the device 104 may define a scanning sequence 510 based on the beacon data and add scan times for the DFS channels. In particular, since the scan lengths 508-1 and 508-3 overlap in the timeline 500, the device 104 may shift the scan length 508-1 for the foreign access point 124-1 by the beacon interval time. In particular, since the expected beacon time 504-3 is later than the expected beacon time 504-1, sequencing the scan of the corresponding foreign access point 124-3 prior to the scan of the foreign access point 124-1 may further shorten the overall length of the scan. The device 104 may designate respective start times 516-3 and 516-1 for the scan lengths 508-3 and 508-1. Further, at block 320, since there is sufficient time before the scan lengths 508-3, the device 104 may sequence an active scan 512 for the foreign access point 124-2 to begin at a start time 520 before the scan length 508-3.

Returning again to FIG. 3, at block 325, the device 104 is configured to perform the access point scan in accordance with the scanning sequence defined at blocks 315 and 320. For example, in the example provided in FIG. 5, the device 104 may first perform an active channel scan for the access point 124-2 at the start time 520, followed by a passive channel scan for the access point 124-3 at the start time 516-3, and finally another passive channel scan for the access point 124-1 at the start time 516-1.

In some examples, blocks 315, 320 and 325 may occur substantially simultaneously and dynamically. For example, if a DFS channel scan utilizes less time than the designated scan length (e.g., does not utilize the buffer period after the expected beacon time), then the device 104 may dynamically re-sequence the channel scans according to the beacon data to optimize the total length of the access point scan.

At block 330, after completing the access point scan to identify the foreign access points 124, the device 104 is configured to select a target access point 124 and roam to the target access point 124. For example, the device 104 may select the target access point 124 having the strongest signal strength, lowest latency and/or jitter, and/or other quality of signal metric or combinations thereof.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A computing device comprising:
a first communications interface configured to connect to a network;
a controller connected to the first communications interface, the controller configured to:
detect a roam condition to scan a plurality of base stations;
obtain, via a second communications interface, beacon data for a subset of the plurality of base stations;
designate a scanning sequence for the plurality of base stations and corresponding channels based on the beacon data for the subset of the plurality of base stations;
scan the corresponding channels according to the scanning sequence that is based on the beacon data for the subset of the plurality of base stations and obtain scan results; and
select a target base station from the plurality of base stations based on the scan results and roam to the target base station.

2. The computing device of claim 1, wherein the subset of the plurality of base stations comprise the base stations operating on dynamic frequency selection channels.

3. The computing device of claim 1, wherein the scanning sequence defines a scan time including a start time and a scan length for each of the corresponding channels, wherein the scan times are non-overlapping.

4. The computing device of claim 3, wherein to designate the scanning sequence, the controller is configured to:
define the start time and the scan length for each channel corresponding to the subset of the plurality of base stations based on the beacon data; and
define the start time and the scan length for each channel corresponding to a remainder of the plurality of base stations.

5. The computing device of claim 4, wherein the beacon data for a given base station comprises a target beacon transmit time and a beacon interval for beacon signals emitted by the given base station.

6. The computing device of claim 5, wherein the scan length for each of the corresponding channels for the subset of the plurality of base stations covers respective buffer periods prior to and after the target beacon transmit time.

7. The computing device of claim 1, wherein to obtain the beacon data, the controller is configured to broadcast a request for the beacon data to secondary devices connected to one of the foreign base stations.

8. The computing device of claim 1, wherein to obtain the beacon data, the controller is configured to broadcast a request for the beacon data to the foreign base stations.

9. The computing device of claim 1, wherein to obtain the beacon data for a given foreign base station, the controller is configured to detect a broadcast signal from the given foreign base station, the broadcast signal containing the beacon data.

10. A method comprising:
detecting a roam condition to scan a plurality of base stations;
obtaining, via a second communications interface, beacon data for a subset of the plurality of base stations;
designating a scanning sequence for the plurality of base stations and corresponding channels based on the beacon data for the subset of the plurality of base stations;
scanning the corresponding channels according to the scanning sequence that is based on the beacon data for the subset of the plurality of base stations and obtain scan results; and
selecting a target base station from the plurality of base stations based on the scan results and roaming to the target base station.

11. The method of claim 10, wherein the subset of the plurality of base stations comprise the base stations operating on dynamic frequency selection channels.

12. The method of claim 10, wherein the scanning sequence defines a scan time including a start time and a scan length for each of the corresponding channels, wherein the scan times are non-overlapping.

13. The method of claim 12, designating the scanning sequence comprises:
define the start time and the scan length for each channel corresponding to the subset of the plurality of base stations based on the beacon data; and
define the start time and the scan length for each channel corresponding to a remainder of the plurality of base stations.

14. The method of claim 13, wherein the beacon data for a given base station comprises a target beacon transmit time and a beacon interval for beacon signals emitted by the given base station.

15. The method of claim 14, wherein each scan length covers buffer periods prior to and after the target beacon transmit time.

16. The method of claim 10, wherein obtaining the beacon data comprises broadcasting a request for the beacon data to secondary devices connected to one of the foreign base stations.

17. The method of claim 10, wherein obtaining the beacon data comprises broadcasting a request for the beacon data to the foreign base stations.

18. The method of claim 10, wherein obtaining the beacon data for a given foreign base station comprises detecting a broadcast signal from the given foreign base station, the broadcast signal containing the beacon data.

19. A non-transitory machine-readable storage medium storing instructions which when executed cause a computing device to:
detect a roam condition to scan a plurality of base stations;
obtain, via a second communications interface, beacon data for a subset of the plurality of base stations;
designate a scanning sequence for the base stations and corresponding channels based on the beacon data for the subset of the plurality of base stations;
scan the corresponding channels according to the scanning sequence that is based on the beacon data for the subset of the plurality of base stations and obtain scan results; and
select a target base station from the plurality of base stations based on the scan results and roam to the target base station.

20. The non-transitory machine-readable storage medium of claim 19, wherein the subset of the plurality of base stations comprise the base stations operating on dynamic frequency selection channels.
